(19) United States
(12) Patent Application Publication
(10) Pub. No.: US 2012/0255385 A1
(43) Pub. Date: Oct. 11, 2012

(54) GEAR DEVICE AND ROTARY ACTUATOR HAVING THE SAME

(75) Inventors: Seiji Nakayama, Obu-city (JP); Taku Itoh, Chita-gun (JP)

(73) Assignee: DENSO CORPORATION, Kariya-city (JP)

(21) Appl. No.: 13/438,937

(22) Filed: Apr. 4, 2012

(30) Foreign Application Priority Data
Apr. 8, 2011 (JP) 2011-86112

(51) Int. Cl. F16H 55/17

(52) U.S. Cl. 74/437

(57) ABSTRACT

A gear device includes a drive gear and a driven gear. The drive gear includes first and second toothed portions, which are coaxial with each other. A radius of a pitch circle of teeth of the first toothed portion of the drive gear is different from a radius of a pitch circle of teeth of the second toothed portion of the drive gear. The first and second toothed portions of the drive gear are displaced from each other in a circumferential direction of the drive gear. The driven gear includes a toothed portion, which is meshed with the first toothed portion of the drive gear.

### CROSS REFERENCE TO RELATED APPLICATION

This application is based on and incorporates herein by reference Japanese Patent Application No. 2011-86112 filed on Apr. 8, 2011.

### BACKGROUND OF THE INVENTION

1. Field of the Invention

The present invention relates to a gear device and a rotary actuator having the same.

2. Description of Related Art

A known shift-by-wire system, which changes a shift range of an automatic transmission, has a rotary actuator as a drive source thereof. For example, Japanese Unexamined Patent Publication JP2009-025222A teaches a rotary actuator that has a speed reducer. The speed reducer reduces a speed of rotation transmitted from an electric motor and outputs the rotation of the reduced speed to a detent mechanism (serving as a drive subject that is driven by the rotary actuator). This speed reducer has a gear device, which includes first and second gears. A radius of a pitch circle of teeth of the first gear is different from a radius of a pitch circle of teeth of the second gear. An input-to-output speed ratio (gear ratio) of the gear device is fixed to a predetermined value. Therefore, a speed reducing ratio of the speed reducer and the rotary actuator is also fixed to a predetermined value.

In the case of the rotary actuator of Japanese Unexamined Patent Publication JP2009-025222A, when a gear device, which has a different input-to-output speed ratio (i.e., a rotary actuator, which has a different speed reducing ratio), needs to be manufactured, the first gear and the second gear need to be changed to other ones. Therefore, it is required to stock different combinations of the first and second gears for the different types of products, which have the different speed reducing ratios, respectively. As a result, the component costs and the manufacturing costs may possibly be increased in such a case.

### SUMMARY OF THE INVENTION

The present invention addresses the above disadvantage. According to the present invention, there is provided a gear device, which includes a primary gear and a secondary gear. The primary gear includes a plurality of primary toothed portions, which are coaxial with each other. Each of the plurality of primary toothed portions includes a plurality of teeth. A radius of a pitch circle of the plurality of teeth of each of the plurality of primary toothed portions is different from a radius of a pitch circle of the plurality of teeth of each of the rest of the plurality of primary toothed portions. Each of the plurality of primary toothed portions is displaced from each of the rest of the plurality of primary toothed portions in a circumferential direction of the primary gear. The secondary gear includes a secondary toothed portion, which includes a plurality of teeth and is meshed with at least one of the plurality of primary toothed portions.

According to the present invention, there is also provided a rotary actuator, which includes the above gear device, a stator, a rotor, a sun gear, a ring gear and an output shaft. The stator is configured into a tubular form. The rotor is placed radially inward of the stator and is rotatably supported. The rotor includes a rotor shaft that has an eccentric portion, which is eccentric to a rotational axis of the rotor. The sun gear is configured into a circular disk form and is rotatably supported by the eccentric portion and includes a plurality of external teeth and an engaging portion. The external teeth are formed along an outer peripheral portion of the sun gear. The engaging portion is engaged with an engaging portion of the primary gear to transmit rotation from the sun gear to the primary gear through the engaging portion of the sun gear and the engaging portion of the primary gear. The ring gear is configured into an annular form and is placed radially outward of the sun gear. The ring gear includes a plurality of internal teeth, which are formed along an inner peripheral portion of the ring gear and are meshed with the plurality of external teeth of the sun gear. The output shaft is placed at a rotational center of the secondary gear and is adapted to rotate integrally with the secondary gear.

### BRIEF DESCRIPTION OF THE DRAWINGS

The invention, together with additional objectives, features and advantages thereof, will be best understood from the following description, the appended claims and the accompanying drawings in which:

FIG. 1 is a plan view of a gear device of a rotary actuator according to a first embodiment of the present invention;

FIG. 2 is a cross-sectional view taken along line II-II in FIG. 1;

FIG. 3 is a cross-sectional view of the rotary actuator of the first embodiment;

FIG. 4 is a schematic view showing a shift range change apparatus of the first embodiment;

FIG. 5 is a plan view of a gear device of a rotary actuator according to a second embodiment of the present invention;

FIG. 6 is a cross-sectional view taken along line VI-VI in FIG. 5;

FIG. 7 is a plan view of a gear device of a rotary actuator according to a third embodiment of the present invention;

FIG. 8 is a cross-sectional view taken along line VIII-VIII in FIG. 7;

FIG. 9 is a plan view of a gear device of a rotary actuator according to a fourth embodiment of the present invention;

FIG. 10 is a cross-sectional view taken along line X-X in FIG. 9;

FIG. 11 is a cross-sectional view of a rotary actuator according to a fifth embodiment of the present invention;

FIG. 12 is a plan view of a gear device of a rotary actuator according to the fifth embodiment;

FIG. 13 is a cross-sectional view taken along line XIII-XIII in FIG. 12;

FIG. 14 is a plan view of a gear device of a rotary actuator according to a sixth embodiment of the present invention;

FIG. 15 is a cross-sectional view taken along line XV-XV in FIG. 14;

FIG. 16 is a plan view of a gear device of a rotary actuator according to a seventh embodiment of the present invention; and

FIG. 17 is a cross-sectional view taken along line XVII-XVII in FIG. 16.

### DETAILED DESCRIPTION OF THE INVENTION

Various embodiments of the present invention will be described with reference to the accompanying drawings.

### First Embodiment

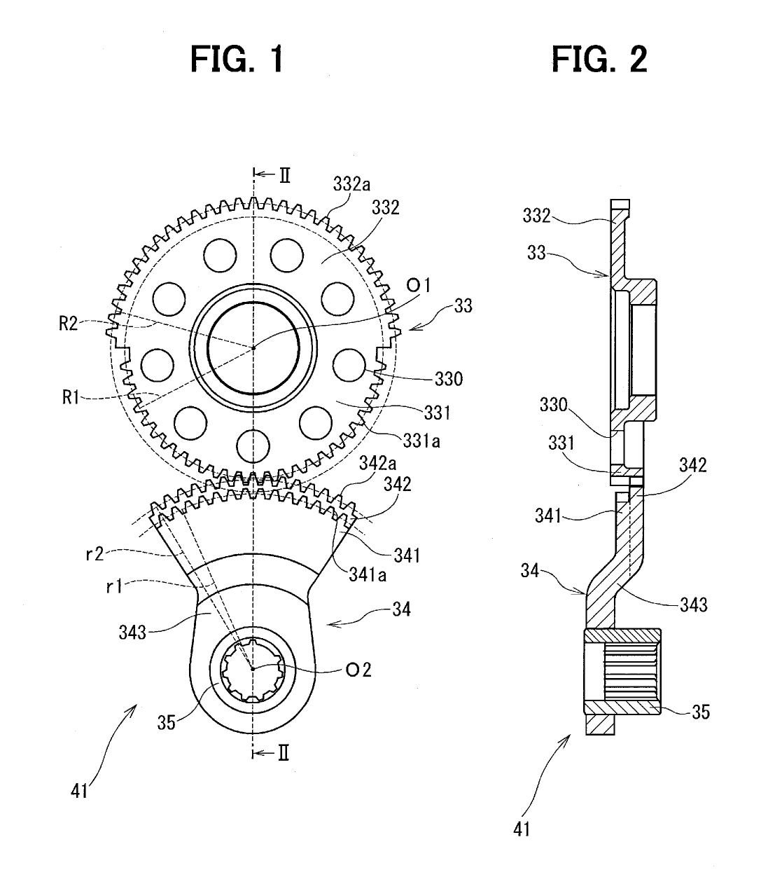

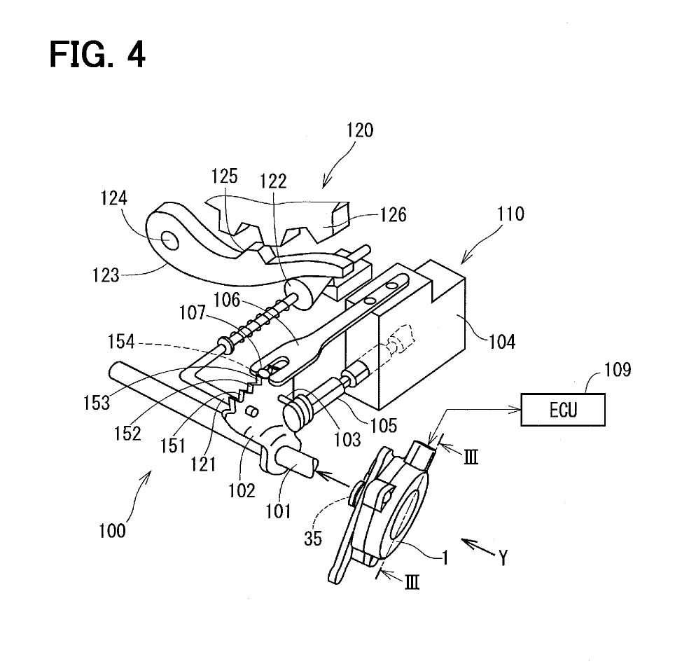

A first embodiment of the present invention will be described with reference to FIGS. 1 to 4. In the first embodiment, the present invention is applied to a rotary actuator, which is installed to a shift range change apparatus of an automatic transmission of a vehicle (automobile). As shown in FIG. 4, the rotary actuator 1 is used to drive the shift range change apparatus 100 in a shift-by-wire system. In the shift range change apparatus 100, a manual shaft 101 is rotated by the rotary actuator 1 to change a shift range of the automatic transmission. An electronic control unit (ECU) 109 controls rotation of the rotary actuator 1. The rotary actuator 1 is installed to the shift range change apparatus 100. Now, the shift range change apparatus 100 will be described.

The shift range change apparatus 100 includes a shift range change mechanism 110 and a parking change mechanism 120.

The shift range change mechanism 110 includes the manual shaft 101, a detent plate 102 and a hydraulic valve body 104. One end portion of the manual shaft 101 is connected to an output shaft 35 of the rotary actuator 1 by means of spline coupling. The detent plate 102 radially outwardly extends from the manual shaft 101 and is configured into a sector shape. The detent plate 102 is rotated integrally with the manual shaft 101. A pin 103, which extends in parallel with the manual shaft 101, is provided in the detent plate 102. The pin 103 is engaged with an end portion of a manual spool valve 105, which is provided in the hydraulic valve body 104. Therefore, the manual spool valve 105 is axially reciprocated by the detent plate 102, which is rotated integrally with the manual shaft 101. The manual spool valve 105 is axially reciprocated to change an active hydraulic fluid passage, through which the hydraulic pressure is supplied to a hydraulic clutch of the automatic transmission, among a plurality of hydraulic fluid passages described below. As a result, the engaging state of the hydraulic clutch is changed to change the shift range of the automatic transmission.

The detent plate 102 includes a plurality of recesses 151-154 at a radially outer end portion of the detent plate 102. The recesses 151-154 correspond to a parking range (P-range), a reverse range (R-range), a neutral range (N-range) and a drive range (D-range), respectively, of the automatic transmission (not shown). When a stopper 107, which is supported at a distal end of a leaf spring 106, is engaged with one of the recesses 151-154, an axial position of the manual spool valve 105 is determined.

When a rotational force is applied from the rotary actuator 1 to the detent plate 102 through the manual shaft 101, the stopper 107 is moved from a currently engaged one to another adjacent one of the recesses (one of the recesses 151-154). In this way, the axial position of the manual spool valve 105 is changed.

In a view taken in a direction of an arrow Y in FIG. 4, when the manual shaft 101 is rotated in a clockwise direction, the pin 103 is driven in the clockwise direction through the detent plate 102. Thus, the pin 103 pushes the manual spool valve 105 toward the interior of the hydraulic valve body 104 to sequentially change the active hydraulic fluid passage in the hydraulic valve body 104 in an order of a hydraulic fluid passage of the D-range, a hydraulic fluid passage of the N-range, a hydraulic fluid passage of the R-range and a hydraulic fluid passage of the P-range. In this way, the shift range of the automatic transmission is changed in the order of the D-range, the N-range, the R-range and the P-range.

On the other hand, when the manual shaft 101 is rotated in the counterclockwise direction, the pin 103 pulls the manual spool valve 105 away from the hydraulic valve body 104, so that the active hydraulic fluid passage in the hydraulic valve body 104 is changed in an order of the hydraulic fluid passage of the P-range, the hydraulic fluid passage of the R-range, the hydraulic fluid passage of the N-range and the hydraulic fluid passage of the D-range. In this way, the shift range of the automatic transmission is changed in the order of the P-range, the R-range, the N-range and the D-range.

As discussed above, the rotational angle (i.e., the predetermined position in the rotational direction) of the manual shaft 101, which is driven by the rotary actuator 1, corresponds to the corresponding shift range of the automatic transmission.

The parking change mechanism 120 includes a park rod 121, a park pole 123 and a parking gear 126. The park rod 121 is configured into a generally L-shape, and the detent plate 102 is connected to one end portion of the park rod 121. A conical portion 122 is provided at the other end portion of the park rod 121. Rotational motion of the detent plate 102 is converted into linear motion of the park rod 121, so that the conical portion 122 is reciprocated in the axial direction. The park pole 123 contacts a side surface (conical surface) of the conical portion 122. Therefore, when the park rod 121 is reciprocated, the park pole 123 is rotated about a shaft 124. A projection 125 is formed in the park pole 123. When the projection 125 is engaged with teeth of the parking gear 126, rotation of the parking gear 126 is limited. In this way, drive wheels of the vehicle are locked through a drive shaft or a differential gear (not shown). In contrast, when the projection 125 of the park pole 123 is disengaged from the teeth of the parking gear 126, rotation of the parking gear 126 is enabled, so that the lock of the drive wheels is unlocked.

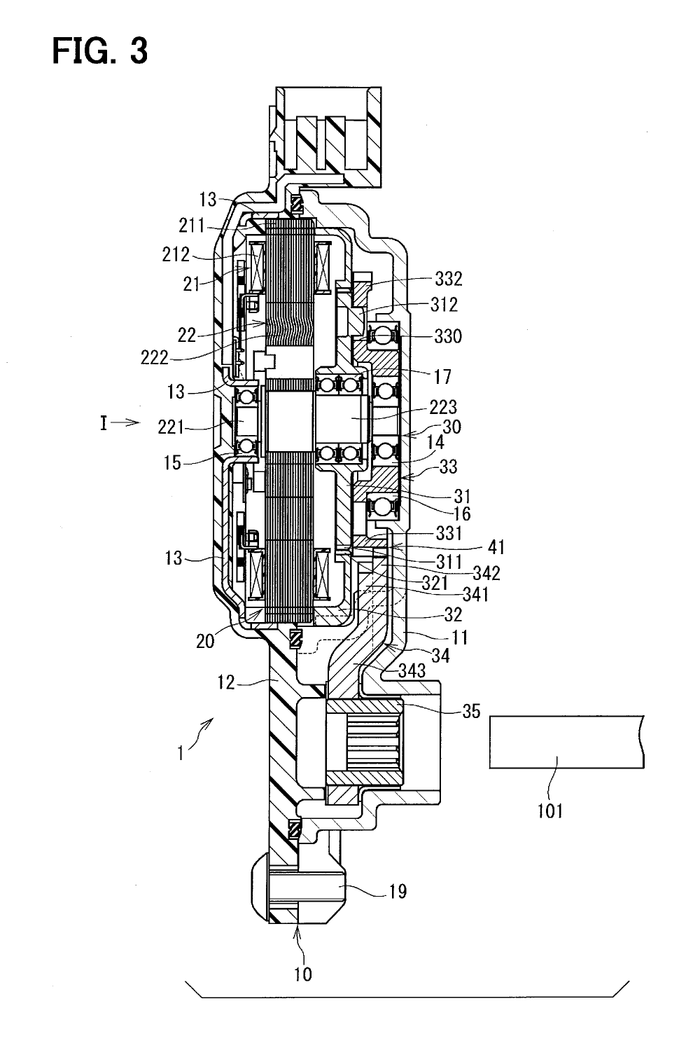

Next, the rotary actuator 1 will be described with reference to FIG. 3.

As shown in FIG. 3, the rotary actuator 1 includes a housing 10, an electric motor 20 and a speed reducer 30. The rotary actuator 1 is a servomotor, which drives the shift range change mechanism 110 of the shift range change apparatus 100.

The speed reducer 30 reduces a speed of rotation, which is transmitted from the electric motor 20, and transmits the rotation of the reduced speed to the shift range change mechanism 110 of the shift range change apparatus 100 through the output shaft 35. Rotation of the electric motor 20 is controlled by the ECU 109, which is connected to the rotary actuator 1. Specifically, in the shift range change apparatus 100, a rotational direction, a rotational speed and a rotational angle of the electric motor 20 are controlled by the ECU 109, and thereby changing operations of the shift range change mechanism 110 and the parking change mechanism 120 are controlled.

The housing 10 includes a front housing 11 and a rear housing 12. In the present embodiment, the front housing 11 is made of a metal material, and the rear housing 12 is made of a resin material. The front housing 11 and the rear housing 12 are fixed together by bolts 19. The electric motor 20 and the speed reducer 30 are received in a space in an inside of the housing 10, which is defined by the front housing 11 and the rear housing 12.

The electric motor 20 is a switched reluctance motor (SR motor), which generates a drive force without using permanent magnets. The electric motor 20 includes a stator 21 and a rotor 22. The stator 21 is configured into an annular form (a ring form, i.e., a cylindrical tubular form) and is press fitted to a stationary plate 13, which is insert molded to the rear housing 12, so that the stationary plate 13 is non-rotatably fixed to the rear housing 12.

The stator 21 includes a stator core 211 and a plurality of coils 212. The stator core 211 is formed by stacking a plurality of thin metal plates one after another in a direction of a plate thickness of the thin metal plates. The stator core 211 includes a plurality of stator teeth, which radially inwardly project and are arranged one after another at predetermined angular intervals (e.g., 30 degree intervals) in a circumferential direction. The coils 212 are wound around the stator teeth to generate a magnetic force at the stator teeth. The ECU 109 controls energization of the coils 212.

The rotor 22 is placed at a location radially inward of the stator 21. The rotor 22 includes a rotor shaft 221 and a rotor core 222. One end portion of the rotor shaft 221 is rotatably supported by a first bearing 14, and the other end portion of the rotor shaft 221 is rotatably supported by a second bearing 15. In this way, the rotor 22 is rotatable relative to the housing 10 and the stator 21.

The first bearing 14 is placed at a location radially inward of a drive gear 33 of the speed reducer 30. Furthermore, the drive gear 33 is rotatably supported by a third bearing 16, which is provided to the front housing 11. Specifically, the one end portion of the rotor shaft 221 is rotatably supported by the front housing 11 through the third bearing 16, the drive gear 33 and the first bearing 14.

In contrast, the second bearing 15 is supported by the rear housing 12.

The rotor core 222 is formed by stacking a plurality of thin metal plates in a direction of a plate thickness of the thin metal plates and is securely press fitted to the rotor shaft 221. The rotor core 222 includes a plurality of rotor teeth, which radially outwardly project toward the stator core 211 located on a radially outer side of the rotor core 222. The rotor teeth of the rotor core 22 are arranged one after another at predetermined angular intervals (e.g., 45 degree intervals) in the circumferential direction.

An energization position and an energization direction of the respective coils 212 are sequentially changed based on a drive signal outputted from the ECU 109, so that magnetically attracting ones of the stator teeth, which are magnetized to magnetically attract the rotor teeth, are sequentially changed, and thereby the rotor 22 is rotated in one rotational direction (normal rotational direction) or the other rotational direction (reverse rotational direction). As discussed above, when the energization of the respective coils 212 is changed to control the magnetic force generated in the respective coils 212, the rotor 22 can be rotated in any one of the normal and reverse rotational directions.

The speed reducer 30 includes a sun gear 31, a ring gear 32, the drive gear 33, a driven gear 34 and the output shaft 35. The rotor shaft 221 includes an eccentric portion 223, which is located on an output shaft 35 side of the rotor core 222 in the axial direction. The eccentric portion 223 is eccentric to the rotational axis of the rotor shaft 221 and is rotated upon rotation of the rotor shaft 221.

The sun gear 31 is configured into a generally circular disk form. The sun gear 31 is supported by a fourth bearing 17 such that the sun gear 31 is rotatable relative to the eccentric portion 223. Therefore, the sun gear 31 is eccentrically rotated relative to the rotor shaft 221. The sun gear 31 includes a plurality of projections 312, each of which axially projects from a front housing 11 side end surface of the sun gear 31. A plurality of external teeth 311 is formed along an outer peripheral portion of the sun gear 31.

The ring gear 32 is configured into a generally annular form (ring form). The ring gear 32 is securely press fitted to the front housing 11. The ring gear 32 has a plurality of internal teeth 321, which are formed along an inner peripheral portion of the ring gear 32 and are adapted to be meshed with the external teeth 311 of the sun gear 31. Therefore, when the sun gear 31 is eccentrically rotated relative to the rotor shaft 221, the external teeth 311 of the sun gear 31 are sequentially meshed with the internal teeth 321 of the ring gear 32, and thereby the sun gear 31 is rotated in an opposite rotational direction, which is opposite from the rotational direction of the rotor shaft 221. A rotational speed of the sun gear 31 is determined based on the number of the external teeth 311 of the sun gear 31 and the number of the internal teeth 321 of the ring gear 32. In the present embodiment, the rotational speed of the sun gear 31 is reduced to, for example, one sixtieth ( 1/60) of the rotational speed of the rotor shaft 221.

Next, a gear device 41, which includes the drive gear 33 and the driven gear 34, will be described with reference to FIGS. 1 to 2. FIG. 1 is a plan view taken in a direction of an arrow I in FIG. 3 and shows a structure of the gear device 41 of the present embodiment. FIG. 2 is a cross-sectional view taken along line II-II in FIG. 1. The drive gear 33 and the driven gear 34 serve as a primary gear and a secondary gear, respectively.

As discussed above, the drive gear 33 is rotatably supported by the third bearing 16, which is provided to the front housing 11. The drive gear 33 includes a plurality of holes 330, which axially extend through the drive gear 33 and are arranged one after another at predetermined intervals in the circumferential direction. The projections 312 are fitted into the holes 330 of the drive gear 33, so that the drive gear 33 is coupled with the sun gear 31 to rotate integrally therewith. The holes 330 serve as first side engaging portions (or simply referred to as engaging portions), and the projections 312 serve as second side engaging portions (or simply referred to as engaging portions).

In the present embodiment, the drive gear 33 includes a first toothed portion 331 and a second toothed portion 332. The first toothed portion 331 and the second toothed portion 332 serve as primary toothed portions, respectively. The first toothed portion 331 and the second toothed portion 332 are provided at two different circumferential locations, respectively of the drive gear 33, i.e., are displaced from each other in the circumferential direction of the drive gear 33. The first toothed portion 331 and the second toothed portion 332 are configured into sector shapes, each of which circumferentially extends 180 degrees (i.e., each of the first toothed portion 331 and the second toothed portion 332 has a central angle of 180 degrees) about a rotational axis (rotational center) O1 of the drive gear 33 that coincides with the rotational axis of the rotor shaft 221. In other words, the first toothed portion 331 and the second toothed portion 332 are configured into semicircular shapes, respectively. The first toothed portion 331 and the second toothed portion 332 extend generally along a common plane (e.g., a plane of FIG. 1). A radius R1 of a pitch circle of a plurality of teeth 331a of the first toothed portion 331 and a radius R2 of a pitch circle of a plurality of teeth 332a of the second toothed portion 332 satisfy the following equation (1).

R1<R2 Equation (1)

The driven gear 34 includes a first toothed portion 341, a second toothed portion 342 and an arm 343. The first toothed portion 341 and the second toothed portion 342 serve as secondary toothed portions, respectively. The first toothed portion 341 and the second toothed portion 342 are configured into sector shapes about a rotational axis (rotational center) O2 of the driven gear 34. Furthermore, the first toothed portion 341 and the second toothed portion 342 are provided at two different axial locations, respectively, i.e., are displaced from each other in the axial direction. A radius r1 of a pitch circle of a plurality of teeth 341a of the first toothed portion 341 and a radius r2 of a pitch circle of a plurality of teeth 342a of the second toothed portion 342 satisfy the following equation (2).

r1<r2 Equation (2)

Here, the radii R1, R2, r1, r2 satisfy the following equation (3).

R1+r2=R2+r1 Equation (3)

In the present embodiment, the drive gear 33 is arranged such that the first toothed portion 331 (more specifically, the teeth 331a) of the drive gear 33 is meshed with the second toothed portion 342 (more specifically, the teeth 342a) of the driven gear 34. Therefore, the driven gear 34 is driven by the drive gear 33 upon rotation of the drive gear 33 such that the second toothed portion 342 of the driven gear 34 is meshed with the first toothed portion 331 of the drive gear 33.

The first toothed portion 341 and the second toothed portion 342 are provided at one end portion of the arm 343. The output shaft 35 is provided at the other end portion of the arm 343 such that the output shaft 35 extends along the rotational axis O2 of the driven gear 34.

The output shaft 35 is rotated integrally with the driven gear 34. The output shaft 35 is coupled with the manual shaft 101 through the spline coupling, as discussed above.

### Second Embodiment

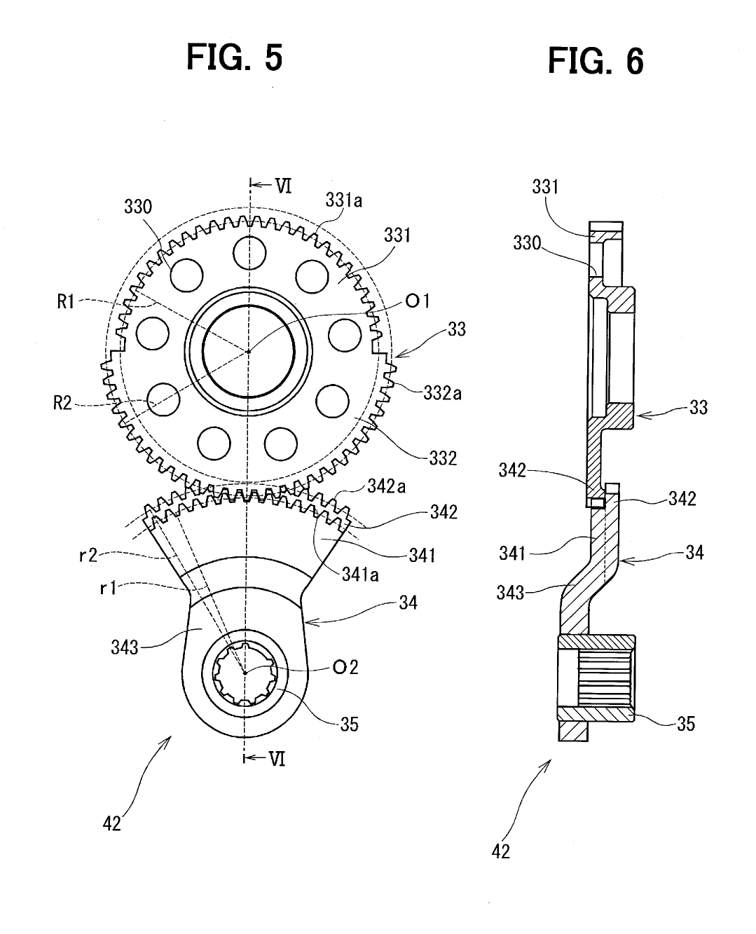

A gear device of the rotary actuator according to a second embodiment of the present invention will be described with reference to FIGS. 5 and 6. In the following description, components, which are similar to those of the first embodiment, will be indicated by the same reference numerals and will not be described further.

In the present embodiment, the drive gear 33 is arranged such that the second toothed portion 332 (more specifically, the teeth 332a) of the drive gear 33 is meshed with the first toothed portion 341 (more specifically, the teeth 341a) of the driven gear 34. Therefore, the gear device 42 is set to have a speed reducing ratio, which is different from that of the gear device 41 of the first embodiment.

In the first and second embodiments, the drive gear 33 includes the first toothed portion 331 and the second toothed portion 332, and the driven gear 34 includes the first toothed portion 341 and the second toothed portion 342. Thereby, at the manufacturing factory where the rotary actuators, which have different speed reducing ratios (different input-to-output speed ratios), respectively, are manufactured, when manufacturing of one rotary actuator having a corresponding speed reducing ratio needs to be switched to manufacturing of another rotary actuator having a different speed reducing ratio, which is different from the current one, it is only required to change a mesh position (meshed teeth) between the drive gear 33 and the driven gear 34 without a need for replacing the drive gear 33 and the driven gear 34. Therefore, it is possible to provide various rotary actuators, which have different speed reducing ratios, respectively, while minimizing the number of required components. Therefore, the costs of the components and the manufacturing costs of the rotary actuator can be reduced or minimized.

### Third Embodiment

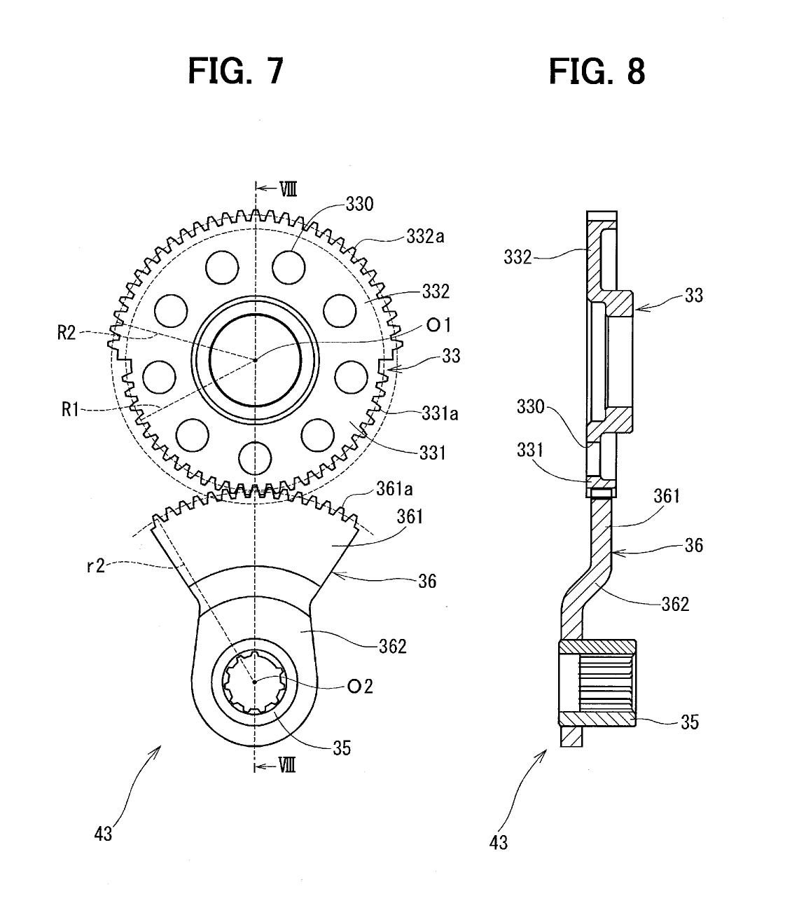

A gear device of the rotary actuator according to a third embodiment of the present invention will be described with reference to FIGS. 7 and 8. In the following description, components, which are similar to those of the first embodiment, will be indicated by the same reference numerals and will not be described further.

In the present embodiment, the gear device 43 includes the drive gear 33 and a driven gear 36. The driven gear 36 includes a toothed portion 361 and an arm 362. The driven gear 36 serves as a secondary gear, and the toothed portion 361 of the driven gear 36 serves as a secondary toothed portion. The toothed portion 361 is configured into a sector shape and has a radius r2 of a pitch circle of a plurality of teeth 361a of the toothed portion 361.

In the present embodiment, the drive gear 33 is arranged such that the first toothed portion 331 (more specifically, the teeth 331a) of the drive gear 33 is meshed with the toothed portion 361 (more specifically, the teeth 361a) of the driven gear 36. An input-to-output speed ratio (speed reducing ratio) of the gear device 43 of the present embodiment is the same as the speed reducing ratio of the gear device 41 of the first embodiment.

The toothed portion 361 is provided at one end portion of the arm 362. The output shaft 35 is provided at the other end portion of the arm 362 such that the output shaft 35 extends along the rotational axis O2 of the driven gear 36. The output shaft 35 is rotated integrally with the driven gear 36.

### Fourth Embodiment

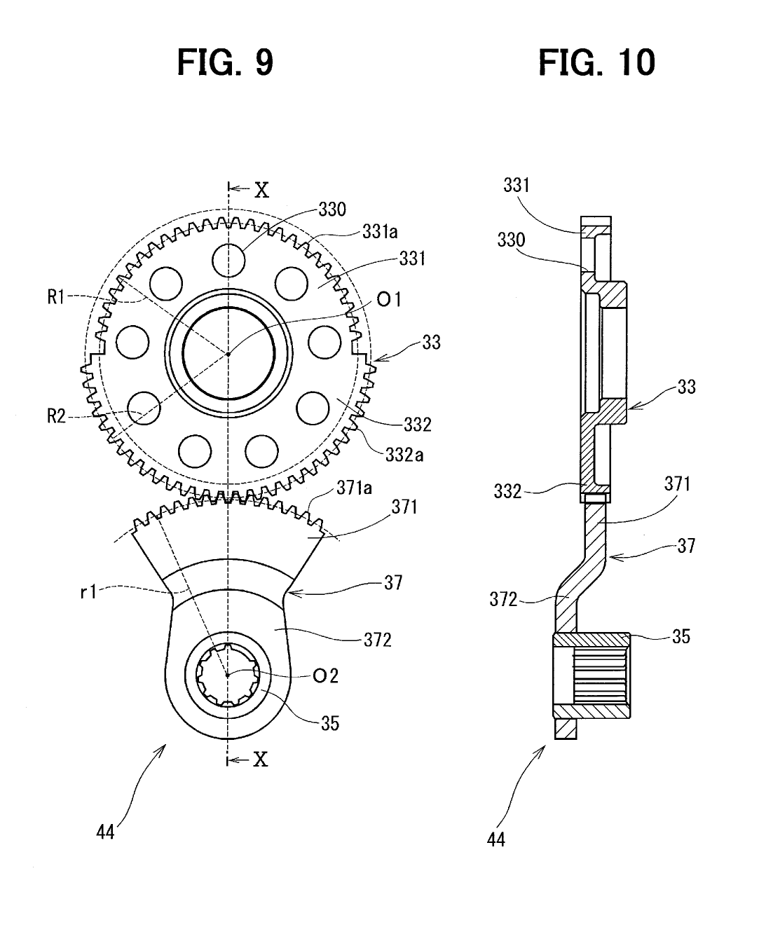

A gear device of the rotary actuator according to a fourth embodiment of the present invention will be described with reference to FIGS. 9 and 10. In the following description, components, which are similar to those of the first embodiment, will be indicated by the same reference numerals and will not be described further.

In the present embodiment, the gear device 44 includes the drive gear 33 and a driven gear 37. The driven gear 37 includes a toothed portion 371 and an arm 372. The driven gear 37 serves as a secondary gear, and the toothed portion 371 of the driven gear 37 serves as a secondary toothed portion. The toothed portion 371 is configured into a sector shape and has a radius r1 of a pitch circle of a plurality of teeth 371a of the toothed portion 371.

In the present embodiment, the drive gear 33 is arranged such that the second toothed portion 332 (more specifically, the teeth 332a) of the drive gear 33 is meshed with the toothed portion 371 (more specifically, the teeth 371a) of the driven gear 37. Therefore, the gear device 44 is set to have a speed reducing ratio, which is different from that of the gear device 43 of the third embodiment. An input-to-output speed ratio (speed reducing ratio) of the gear device 44 of the present embodiment is the same as the speed reducing ratio of the gear device 42 of the second embodiment.

The toothed portion 371 is provided at one end portion of the arm 372. The output shaft 35 is provided at the other end portion of the arm 372 such that the output shaft 35 extends along the rotational axis O2 of the driven gear 37. The output shaft 35 is rotated integrally with the driven gear 37.

In comparison between the third and fourth embodiments, the same member (the drive gear 33) is provided as the drive gear, and the different member (the driven gear 36, the driven gear 37) is provided as the driven gear. Thereby, at the manufacturing factory where the rotary actuators, which have different speed reducing ratios (input-to-output speed ratios), respectively, are manufactured, when manufacturing of one rotary actuator having a corresponding speed reducing ratio needs to be switched to manufacturing of another rotary actuator having a different speed reducing ratio, which is different from the current one, it is only required to change the driven gear 36 or the driven gear 37. Therefore, it is possible to provide various rotary actuators, which have different speed reducing ratios, respectively, while minimizing the number of required components. Therefore, the costs of the components and the manufacturing costs of the rotary actuator can be reduced or minimized.

### Fifth Embodiment

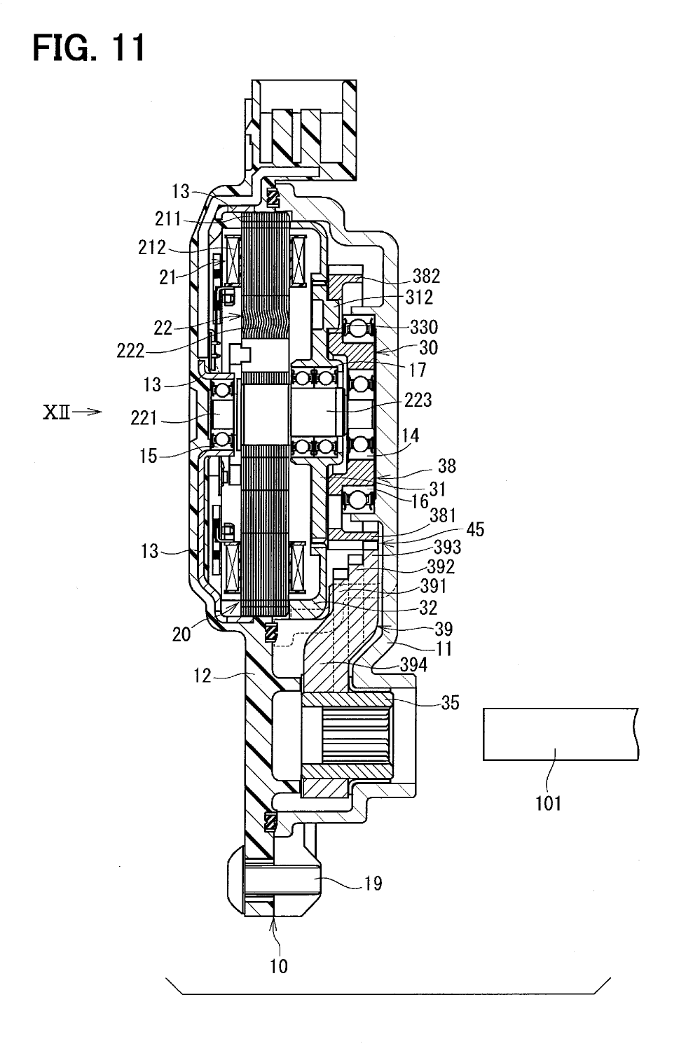

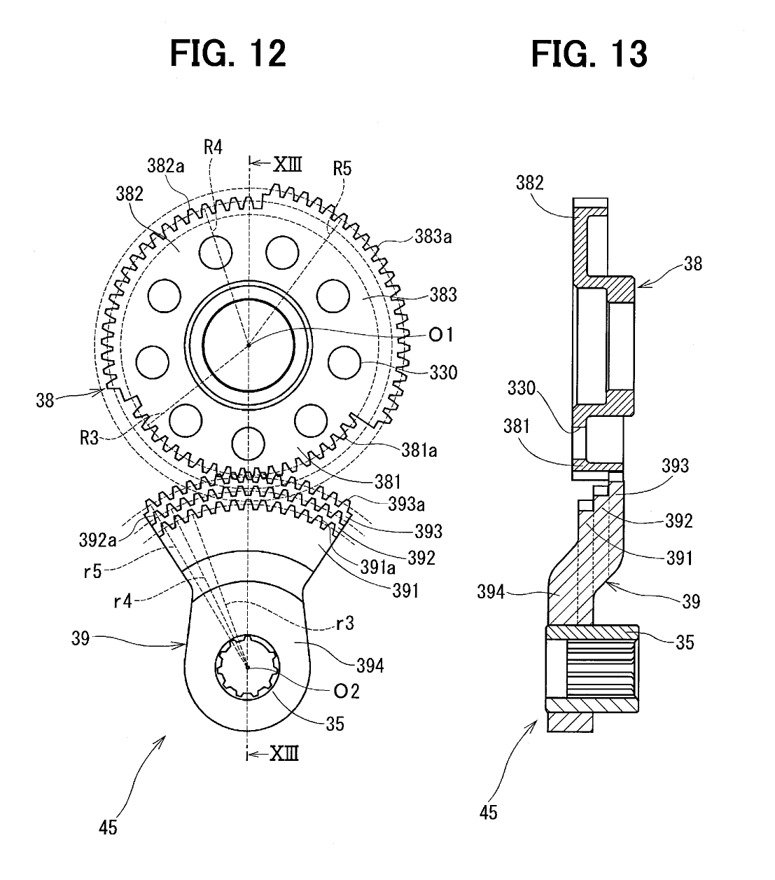

FIG. 11 shows a fifth embodiment of the present invention. A gear device, which is used in a rotary actuator of the fifth embodiment, will be described with reference to FIGS. 12 and 13. In the following description, components, which are similar to those of the first embodiment, will be indicated by the same reference numerals and will not be described further. FIG. 12 is a plan view taken in a direction of an arrow XII in FIG. 11 and shows a gear device 45 of the fifth embodiment.

In the present embodiment, the gear device 45 includes a drive gear 38 and a driven gear 39. The drive gear 38 includes first toothed portion 381, a second toothed portion 382 and a third toothed portion 383. The drive gear 38 serves as a primary gear. The first to third toothed portions 381-383 serve as primary toothed portions, respectively. The first to third toothed portions 381-383 are configured into sector shapes, each of which circumferentially extends 120 degrees (i.e., each of the first to third toothed portions 381-383 has a central angle of 120 degrees) about the rotational axis O1 of the drive gear 38, which coincides with the rotational axis of the rotor shaft 221. The first to third toothed portions 381-383 are provided at three different circumferential locations, respectively of the drive gear 33, i.e., are displaced from each other in the circumferential direction of the drive gear 38. The first to third toothed portions 381-383 extend generally along a common plane. A radius R3 of a pitch circle of a plurality of teeth 381a of the first toothed portion 381, a radius R4 of a pitch circle of a plurality of teeth 382a of the second toothed portion 382, and a radius R5 of a pitch circle of a plurality of teeth 383a of the third toothed portion 383 satisfy the following equation (4).

R3<R4<R5 Equation (4)

The driven gear 39 includes a first toothed portion 391, a second toothed portion 392, a third toothed portion 393 and an arm 394. The driven gear 39 serves as a secondary gear. The first to third toothed portions 391-393 serve as secondary toothed portions, respectively. The first to third toothed portions 391-393 are configured into sector shapes about the rotational axis O2 of the driven gear 39. Furthermore, the first to third toothed portions 391-393 are provided at three different axial locations, respectively, i.e., are displaced from each other in the axial direction. A radius r3 of a pitch circle of a plurality of teeth 391a of the first toothed portion 391, a radius r4 of a pitch circle of a plurality of teeth 392a of the second toothed portion 392, and a radius r5 of a pitch circle of a plurality of teeth 393a of the third toothed portion 393 satisfy the following equation (5).

r3<r4<r5 Equation (5)

The radii R3-R5, r3-r5 satisfy the following equation (6).

R3+r5=R4+r4=R5+r3 Equation (6)

In the present embodiment, the drive gear 38 is arranged such that the first toothed portion 381 (more specifically, the teeth 381a) of the drive gear 38 is meshed with the third toothed portion 393 (more specifically, the teeth 393a) of the driven gear 39.

The first to third toothed portions 391-393 are provided at one end portion of the arm 394. The output shaft 35 is provided at the other end portion of the arm 394 such that the output shaft 35 extends along the rotational axis O2 of the driven gear 39. The output shaft 35 is rotated integrally with the driven gear 39.

### Sixth Embodiment

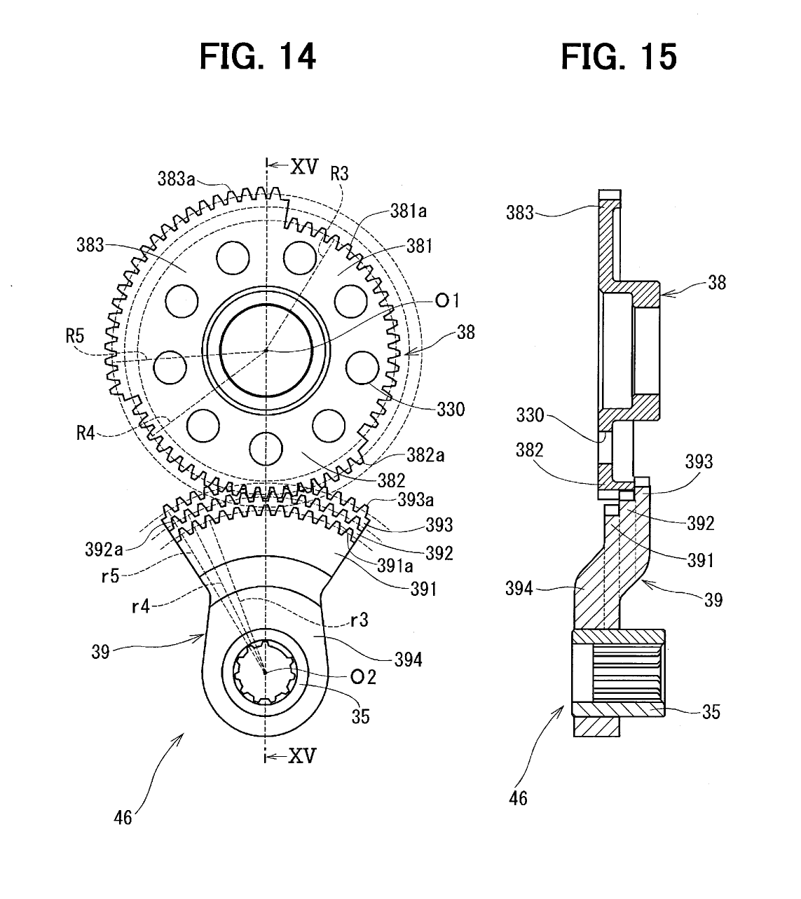

A gear device of the rotary actuator according to a sixth embodiment of the present invention will be described with reference to FIGS. 14 and 15. In the following description, components, which are similar to those of the fifth embodiment, will be indicated by the same reference numerals and will not be described further.

In the present embodiment, the drive gear 38 is arranged such that the second toothed portion 382 (more specifically, the teeth 382a) of the drive gear 38 is meshed with the second toothed portion 392 (more specifically, the teeth 392a) of the driven gear 39. Therefore, the gear device 46 of the present embodiment has an input-to-output speed ratio, which is different from that of the gear device 45 of the fifth embodiment.

### Seventh Embodiment

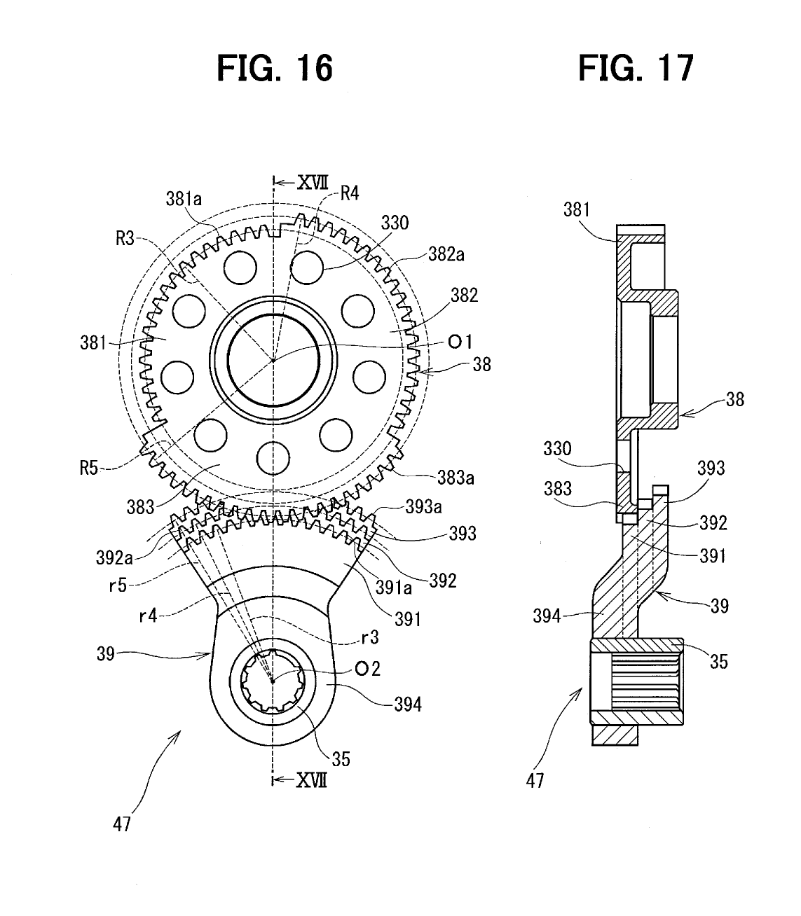

A gear device of the rotary actuator according to a seventh embodiment of the present invention will be described with reference to FIGS. 16 and 17. In the following description, components, which are similar to those of the fifth embodiment, will be indicated by the same reference numerals and will not be described further.

In the present embodiment, the drive gear 38 is arranged such that the third toothed portion 383 (more specifically, the teeth 383a) of the drive gear 38 is meshed with the first toothed portion 391 (more specifically, the teeth 391a) of the driven gear 39. Therefore, the gear device 47 is set to have an input-to-output speed ratio, which is different from the gear device 45 of the fifth embodiment and the gear device 46 of the sixth embodiment.

In the fifth to seventh embodiments, the drive gear 38 includes the first to third toothed portions 381-383. The driven gear 39 includes the first to third toothed portions 391-393. Thereby, at the manufacturing factory where the rotary actuators, which have different speed reducing ratios (different input-to-output speed ratios), respectively, are manufactured, when manufacturing of one rotary actuator having a corresponding speed reducing ratio needs to be switched to manufacturing of another rotary actuator having a different speed reducing ratio, which is different from the current one, it is only required to change a mesh position (meshed teeth) between the drive gear 38 and the driven gear 39 without a need for replacing the drive gear 38 and the driven gear 39. Therefore, it is possible to provide various rotary actuators, which have different speed reducing ratios, respectively, while minimizing the number of required components. Therefore, the costs of the components and the manufacturing costs of the rotary actuator can be reduced or minimized.

Now, modifications of the above embodiments will be described.

In the above embodiments, the gear device is applied to the speed reducer of the rotary actuator. Alternatively, the gear device of the present invention may be applied to a speed increaser, in which a speed of rotation of an output is increased from a speed of rotation of an input.

In some of the above embodiments, there is recited the gear device that has the drive gear, which includes the first and second toothed portions, and the driven gear, which includes the toothed portion that is adapted to mesh with the first or second toothed portion of the drive gear. Alternatively, the gear device of the some of the above embodiments may be modified as follows. Specifically, the gear device may have a driven gear, which includes first and second toothed portions, and a drive gear, which includes a toothed portion that is adapted to mesh with the first or second toothed portion of the driven gear.

In some of the above embodiments, there is recited the gear device that includes the drive gear, which includes the first to third toothed portions, and the driven gear, which includes the first to third toothed portions. Alternatively, the gear device may have the drive gear, which includes the first to third toothed portions, and the driven gear, which includes a toothed portion that is adapted to mesh with one of the first to third toothed portions of the drive gear.

Additional advantages and modifications will readily occur to those skilled in the art. The invention in its broader terms is therefore not limited to the specific details, representative apparatus, and illustrative examples shown and described.

What is claimed is:

1. A gear device comprising:
a primary gear that includes a plurality of primary toothed portions, which are coaxial with each other, wherein:
each of the plurality of primary toothed portions includes a plurality of teeth;
a radius of a pitch circle of the plurality of teeth of each of the plurality of primary toothed portions is different from a radius of a pitch circle of the plurality of teeth of each of the rest of the plurality of primary toothed portions; and
each of the plurality of primary toothed portions is displaced from each of the rest of the plurality of primary toothed portions in a circumferential direction of the primary gear; and
a secondary gear that includes a secondary toothed portion, which includes a plurality of teeth and is meshed with at least one of the plurality of primary toothed portions.

2. The gear device according to claim 1, wherein:
the secondary toothed portion of the secondary gear is one of a plurality of secondary toothed portions of the secondary gear, which are coaxial with each other and each of which includes a plurality of teeth, wherein a radius of a pitch circle of the plurality of teeth of each of the plurality of secondary toothed portions is different from a radius of a pitch circle of the plurality of teeth of each of the rest of the plurality of secondary toothed portions; and
each of the plurality of secondary toothed portions is displaced from each of the rest of the plurality of secondary toothed portions in an axial direction of the secondary gear.

3. The gear device according to claim 1, wherein:
a distance between a rotational axis of the primary gear and a rotational axis of the secondary gear is fixed;
an input-to-output speed ratio of the gear device is changeable without changing the primary gear and the secondary gear or by changing one of the primary gear and the secondary gear;
the primary gear is a drive gear; and
the secondary gear is a driven gear, which is driven by the drive gear.

4. A rotary actuator comprising:
the gear device of claim 1;
a stator that is configured into a tubular form;
a rotor that is placed radially inward of the stator and is rotatably supported, wherein the rotor includes a rotor shaft that has an eccentric portion, which is eccentric to a rotational axis of the rotor;
a sun gear that is configured into a circular disk form and is rotatably supported by the eccentric portion and includes:
a plurality of external teeth, which are formed along an outer peripheral portion of the sun gear; and
an engaging portion, which is engaged with an engaging portion of the primary gear to transmit rotation from the sun gear to the primary gear through the engaging portion of the sun gear and the engaging portion of the primary gear;
a ring gear that is configured into an annular form and is placed radially outward of the sun gear, wherein the ring gear includes a plurality of internal teeth, which are formed along an inner peripheral portion of the ring gear and are meshed with the plurality of external teeth of the sun gear; and
an output shaft that is placed at a rotational center of the secondary gear and is adapted to rotate integrally with the secondary gear.
